(19) United States
(12) Patent Application Publication
(10) Pub. No.: US 2026/0360992 A1
(43) Pub. Date: Nov. 12, 2026

(54) CIRCULARLY POLARIZED ANTENNA AND METHOD OF MANUFACTURING THE SAME

(71) Applicant: ELECTRONICS AND TELECOMMUNICATIONS RESEARCH INSTITUTE, Daejeon (KR)

(72) Inventors: Seong Mo MOON, Daejeon (KR); Dong Hwan SHIN, Daejeon (KR); Jongho YOO, Daejeon (KR); Dong Pil CHANG, Daejeon (KR); Han Lim LEE, Seoul (KR); Seung-Soo HAN, Seoul (KR)

(73) Assignee: ELECTRONICS AND TELECOMMUNICATIONS RESEARCH INSTITUTE, Daejeon (KR)

(21) Appl. No.: 19/667,605

(22) Filed: May 4, 2026

(30) Foreign Application Priority Data
May 7, 2025 (KR) 10-2025-0058838

(51) Int. Cl. H01Q 19/00; H01Q 9/04

(52) U.S. Cl. CPC H01Q 19/005; H01Q 9/0414; H01Q 9/0428

(57) ABSTRACT

An antenna for inter-satellite communication is provided. The antenna includes a substrate including a dielectric, a driven patch positioned on the substrate and including a plurality of second unit patches, and a patch layer positioned on the driven patch and including a first parasitic patch and a second parasitic patch. Each of the plurality of second unit patches includes a plurality of antenna elements, the first parasitic patch includes a first pattern that overlaps with the plurality of antenna elements, and the second parasitic patch includes a second pattern that does not overlap with the plurality of antenna elements.

### CROSS-REFERENCE TO RELATED APPLICATION

This application claims the benefit of Korean Patent Application No. 10-2025-0058838, filed on May 7, 2025, in the Korean Intellectual Property Office (now the Ministry of Intellectual Property (MOIP)), the entire disclosure of which is incorporated herein by reference for all purposes.

### BACKGROUND

### 1. Field of the Invention

One or more embodiments relate to a circularly polarized (CP) antenna and a method of manufacturing the same.

### 2. Description of the Related Art

With the rapid development of low earth orbit (LEO) satellite communication systems, the importance of high-gain phased array antennas is growing. LEO satellites may travel faster than geostationary orbit (GEO) and medium Earth orbit (MEO) satellites. Thousands of LEO satellites may be operated simultaneously to support extensive global communication services. Accordingly, high beamforming precision, fast beam switching, and lightweight and miniaturized antenna modules may be essential for LEO satellites.

Communications in a Ka band may provide high data transmission rates and low latency. Accordingly, the communications in the Ka band may be a key technology for inter-satellite data transmission and the construction of ultra-high-speed satellite networks. Due to high frequency characteristics of the Ka band, a signal loss is significant, and a physical size of the antenna decreases, making it difficult to optimize the beam steering and the gain of the antenna. Accordingly, it may be necessary to develop active phased array antenna (APAA) and a broadband circularly polarized (CP) antenna structures with an electronic beam steering technology applied.

The above description is information the inventor(s) acquired during the course of conceiving the present disclosure, or already possessed at the time, and is not necessarily art publicly known before the present application was filed.

### SUMMARY

An antenna according to an embodiment may include a patch layer positioned on a driven patch.

A patch layer according to an embodiment may include a parasitic patch that overlaps with a plurality of antenna elements of a driven patch.

A patch layer according to an embodiment may include a parasitic patch that does not overlap with a plurality of antenna elements of a driven patch.

However, the technical aspects are not limited to the aspects described above, and there may be other technical aspects.

According to an aspect, there is provided an antenna including a substrate including a dielectric, a driven patch positioned on the substrate and including a plurality of second unit patches, and a patch layer positioned on the driven patch and including a first parasitic patch and a second parasitic patch, wherein each of the plurality of second unit patches includes a plurality of antenna elements, the first parasitic patch includes a first pattern that overlaps with the plurality of antenna elements, and the second parasitic patch includes a second pattern that does not overlap with the plurality of antenna elements.

The first parasitic patch may be disposed on one surface of a substrate included in the patch layer, and the second parasitic patch may be disposed on the other surface of the substrate included in the patch layer.

The first pattern may include a plurality of first unit patches, and each of the plurality of first unit patches may be diagonal-shaped to overlap with each of the plurality of antenna elements.

Each of the plurality of first unit patches may include 4 diagonal shapes, and each of the diagonal shapes may be disposed to have a difference of 90 degrees from an adjacent diagonal shape.

The second pattern may include a plurality of second unit patches, and each of the plurality of second unit patches may be cross-shaped to cross between the plurality of antenna elements.

The second parasitic patch may further include a third pattern, the third pattern may have a shape of an outline of a rectangle surrounding the plurality of second unit patches, and the outline may be broken at regular intervals.

The second parasitic patch may further include a fourth pattern, and the fourth pattern may have a shape of an outline of a rectangle having a size greater than the rectangle and surrounding the plurality of second unit patches.

According to another aspect, there is provided a method of manufacturing an antenna, the method including disposing a substrate including a dielectric on an antenna ground, forming a driven patch positioned on the substrate and including a plurality of second unit patches, and forming a patch layer including a first parasitic patch and a second parasitic patch on the driven patch, wherein each of the plurality of second unit patches includes a plurality of antenna elements, the first parasitic patch includes a first pattern that overlaps with the plurality of antenna elements, and the second parasitic patch includes a second pattern that does not overlap with the plurality of antenna elements.

The first parasitic patch may be disposed on one surface of a substrate included in the patch layer, and the second parasitic patch may be disposed on the other surface of the substrate included in the patch layer.

The first pattern may include a plurality of first unit patches, and each of the plurality of first unit patches may be diagonal-shaped to overlap with each of the plurality of antenna elements.

Each of the plurality of first unit patches may include 4 diagonal shapes, and each of the diagonal shapes may be disposed to have a difference of 90 degrees from an adjacent diagonal shape.

The second pattern may include a plurality of second unit patches, and each of the plurality of second unit patches may be cross-shaped to cross between the plurality of antenna elements.

The second parasitic patch may further include a third pattern, the third pattern may have a shape of an outline of a rectangle surrounding the plurality of second unit patches, and the outline may be broken at regular intervals.

The second parasitic patch may further include a fourth pattern, and the fourth pattern may have a shape of an outline of a rectangle having a size greater than the rectangle and surrounding the plurality of second unit patches.

According to still another aspect, there is provided an electronic device for inter-satellite communication, the electronic device including an antenna, a processor, and a memory, wherein the antenna includes a substrate including a dielectric, a driven patch positioned on the substrate and including a plurality of second unit patches, and a patch layer positioned on the driven patch and including a first parasitic patch and a second parasitic patch, each of the plurality of second unit patches includes a plurality of antenna elements, the first parasitic patch includes a first pattern that overlaps with the plurality of antenna elements, and the second parasitic patch includes a second pattern that does not overlap with the plurality of antenna elements.

The first parasitic patch may be disposed on one surface of a substrate included in the patch layer, and the second parasitic patch may be disposed on the other surface of the substrate included in the patch layer.

The first pattern may include a plurality of first unit patches, and each of the plurality of first unit patches may be diagonal-shaped to overlap with each of the plurality of antenna elements.

Each of the plurality of first unit patches may include 4 diagonal shapes, and each of the diagonal shapes may be disposed to have a difference of 90 degrees from an adjacent diagonal shape.

The second pattern may include a plurality of second unit patches, and each of the plurality of second unit patches may be cross-shaped to cross between the plurality of antenna elements.

The second parasitic patch may further include a third pattern, the third pattern may have a shape of an outline of a rectangle surrounding the plurality of second unit patches, and the outline may be broken at regular intervals.

The second parasitic patch may further include a fourth pattern, and the fourth pattern may have a shape of an outline of a rectangle having a size greater than the rectangle and surrounding the plurality of second unit patches.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an antenna according to an embodiment;

FIG. 2 is a diagram illustrating a driven patch according to an embodiment;

FIG. 3 is a diagram illustrating an array of a plurality of antenna elements according to an embodiment;

FIG. 4 is a diagram illustrating a stacked structure of an antenna according to an embodiment;

FIG. 5 is a diagram illustrating a first parasitic patch according to an embodiment;

FIG. 6 is a diagram illustrating a second parasitic patch according to an embodiment;

FIG. 7 is a diagram illustrating another example of a second parasitic patch according to an embodiment;

FIG. 8 is a diagram illustrating an electromagnetic simulation result of an antenna according to an embodiment;

FIG. 9 is a flowchart illustrating a method of manufacturing an antenna according to an embodiment; and

FIG. 10 is a schematic block diagram illustrating an electronic device according to an embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

Although terms of "first," "second," and the like are used to explain various components, the components are not limited to such terms. These terms are used only to distinguish one component from another component. For example, a first component may be referred to as a second component, or similarly, the second component may be referred to as the first component.

It should be noted that if one component is described as being "connected", "coupled", or "joined" to another component, a third component may be "connected", "coupled", and "joined" between the first and second components, although the first component may be directly connected, coupled, or joined to the second component.

As used herein, the singular forms "a," "an," and "the" are intended to include the plural forms as well, unless the context clearly indicates otherwise. As used herein, "A or B," "at least one of A and B," "at least one of A or B," "A, B or C," "at least one of A, B and C," and "at least one of A, B, or C," each of which may include any one of the items listed together in the corresponding one of the phrases, or all possible combinations thereof. It will be further understood that the terms "comprises" and/or "comprising," when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments are described in detail with reference to the accompanying drawings. When describing the embodiments with reference to the accompanying drawings, like reference numerals refer to like components and a repeated description related thereto will be omitted.

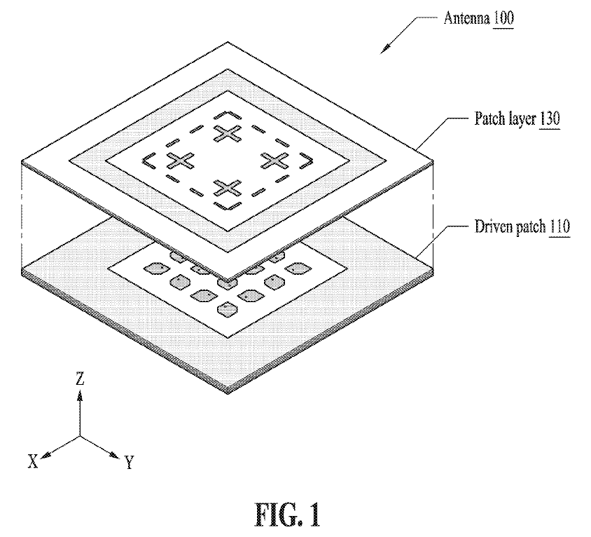

FIG. 1 is a diagram illustrating an antenna according to an embodiment.

Referring to FIG. 1, an antenna 100 according to an embodiment may include a driven patch 110 and a patch layer 130.

The antenna 100 may be a circularly polarized (CP) antenna for an inter-satellite communication. The antenna 100 may operate at a high gain and a wide bandwidth for the inter-satellite communication. For example, the antenna 100 may operate in a Ka-band. The antenna 100 may be an antenna with a sequential rotation method applied. The antenna 100 may be an electronically scanned array (ESA) antenna. The ESA antenna may support beam steering.

The antenna 100 may include a stacked structure (or a multilayer structure) in which the driven patch 110, the patch layer 130, and a beamforming integrated circuit (IC) (not shown) are combined. The antenna 100 may maintain a high gain through the stacked structure. The antenna 100 may reduce a gain change rate due to a frequency change through the stacked structure.

The driven patch 110 may be a radiation patch that receives power feeding. The driven patch 110 may obtain an electrical signal from the outside. The driven patch 110 may radiate electromagnetic waves based on the obtained signal. The driven patch 110 may include a plurality of antenna elements.

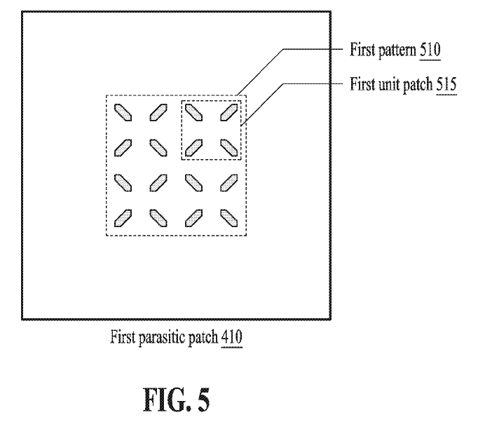

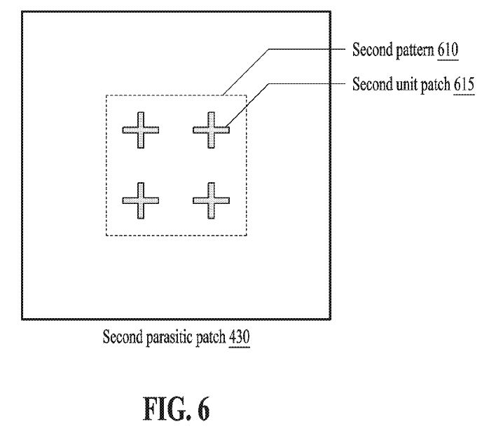

The patch layer 130 may be provided to adjust the radiation characteristics of the driven patch 110. The patch layer 130 may include a plurality of parasitic patches (e.g., a first parasitic patch 410 of FIG. 5 and a second parasitic patch 430 of FIG. 6). The plurality of parasitic patches may include different patterns from each other. The plurality of parasitic patches may be non-feeding elements.

An antenna of the related art may maintain circular polarization characteristics only in a specific frequency band since an axial ratio bandwidth is narrow. The antenna for the inter-satellite communication may need to secure a wide axial ratio bandwidth to enable a stable communication in various frequency environments. In addition, since an inter-satellite communication link must transmit and receive signals at various angles and through various paths, an antenna with a low gain change rate may be required. The antenna 100 may have predetermined polarization characteristics for an optimal communication. The antenna 100 may be designed to maintain a predetermined gain even while a satellite is moving.

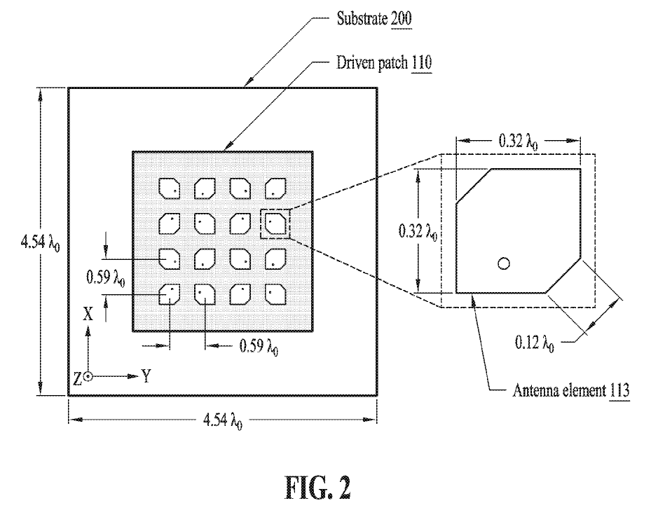

FIG. 2 is a diagram illustrating a driven patch according to an embodiment.

Referring to FIG. 2, according to an embodiment, the antenna 100 may be a circularly polarized (CP) antenna that generates circular polarization. The antenna 100 may include a substrate 200 and the driven patch 110. The driven patch 110 may be positioned on a substrate 200 having a planar structure containing a dielectric.

The driven patch 110 may have a square shape. For example, the driven patch 110 may be a square with a size of 4.54 λ₀ x 4.54 λ₀. The driven patch 110 may include a plurality of antenna elements. The plurality of antenna elements may be arranged in a 4 x 4 array. A center of the array may correspond to a center of a feed network of the antenna 100. The feed network of the antenna 100 may be configured as a single-feed structure.

An antenna element 113 may have a structure to which a truncated technique is applied. The truncated technique may be to cut corners of the antenna element 113 asymmetrically. The truncated technique may be intended to induce a phase difference between orthogonal modes. Accordingly, the single antenna element 113, to which the truncated technique is applied, may have circular polarization characteristics at a single element level.

The antenna element 113 may have a square shape. For example, the antenna element 113 may be a square with a size of 0.32 λ₀ x 0.32 λ₀. The antenna element 113 may have a shape such that a portion of the corner of the antenna element 113 is cut to have a length of 0.15 λ₀ by applying the truncated technique.

The antenna 100 may operate in a center frequency band. The center frequency band may be 27 GHz. The antenna 100 may continuously maintain circular polarization characteristics through the array of the plurality of antenna elements arranged in a sequentially rotated manner. By combining the array of the plurality of antenna elements arranged in a sequentially rotated manner and a single-feed method, the feed network of the antenna 100 may be simplified and the manufacturing of the antenna 100 may be made easier.

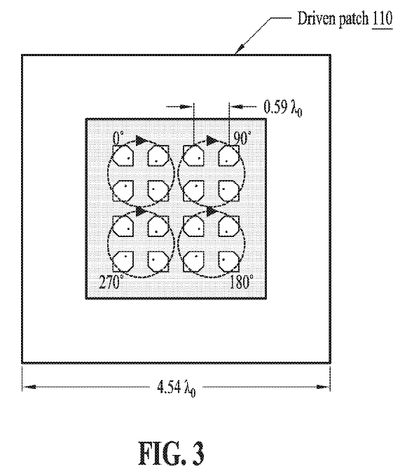

FIG. 3 is a diagram illustrating an array of a plurality of antenna elements according to an embodiment.

Referring to FIG. 3, according to an embodiment, a plurality of antenna elements may be arranged in a sequentially rotated manner.

The plurality of antenna elements may be arranged on the driven patch 110. The plurality of antenna elements may be arranged with a 2 x 2 array as a unit array, and disposed to have a difference of 90 degrees from adjacent antenna elements. Accordingly, the plurality of antenna elements may be arranged to have a predetermined directionality. The plurality of antenna elements may be arranged so as to have a spacing of 0.59 λ₀ between antenna elements.

The antenna 100 may secure a wide axial ratio bandwidth through the driven patch 110 to which a sequential rotation method is applied. The circular polarization performance of the antenna 100 may be improved by using the driven patch 110 to which the sequential rotation method is applied.

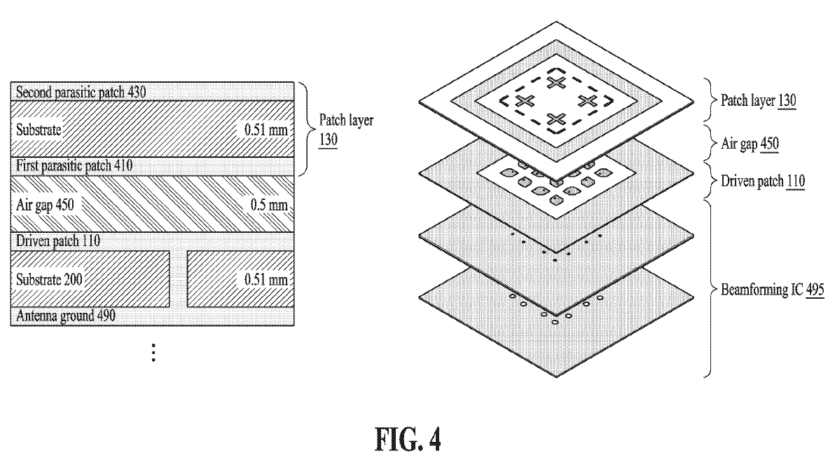

FIG. 4 is a diagram illustrating a stacked structure of an antenna according to an embodiment.

Referring to FIG. 4, according to an embodiment, the antenna 100 may include the patch layer 130, an air gap 450, the substrate 200, an antenna ground 490, and a beamforming IC 495. The patch layer 130 may include the first parasitic patch 410, a substrate, and the second parasitic patch 430. The driven patch 110 may be disposed on the substrate 200.

The patch layer 130 may be provided to adjust a radiation pattern of the driven patch 110. The patch layer 130 may include the substrate and have a structure in which the first parasitic patch 410 and the second parasitic patch 430 are disposed on the substrate. For example, the first parasitic patch 410 may be disposed on one surface of the substrate included in the patch layer 130, and the second parasitic patch 430 may be disposed on the other surface of the substrate included in the patch layer 130. The substrate may have a thickness of 0.51 mm. The patch layer 130 may be disposed at a position spaced apart from the driven patch 110. The patch layer 130 may be disposed on the driven patch 110.

The air gap 450 may be disposed between the patch layer 130 and the driven patch 110. The air gap 450 may be provided to reduce a radiation loss of the driven patch 110. The air gap 450 may be provided to reduce a phase error of the plurality of antenna elements of the driven patch 110. The air gap 450 may have a thickness of 0.5 mm. The air gap 450 may be provided to improve impedance matching performance of the antenna 100. The air gap 450 may be provided to maintain the circular polarization characteristics of the antenna 100. The antenna 100 having the structure of the air gap 450 may operate in a wide band compared to the antenna 100 of the related art including a single layer.

The beamforming IC 495 may control the phase of the plurality of antenna elements included in the driven patch 110. The beamforming IC 495 may be designed to enable electronically scanned beam steering. The beamforming IC 495 may steer a beam in real time. The antenna 100 may maintain optimal directionality by rapidly detecting signal changes through the beamforming IC 495.

The driven patch 110 of the antenna 100 may be combined with the beamforming IC 495. The antenna 100 may be designed to maintain a high gain and wide band characteristics through the stacked structure described with reference to FIG. 3. The antenna 100 may provide improved circular polarization performance and a minimized gain change rate through the stacked structure.

FIG. 5 is a diagram illustrating a first parasitic patch according to an embodiment.

Referring to FIG. 5, according to an embodiment, the first parasitic patch 410 may include a first pattern 510. The first pattern 510 may include a first unit patch 515.

The first parasitic patch 410 may be electromagnetically coupled with the driven patch 110. The first parasitic patch 410 may affect the radiation characteristics of the driven patch 110 through the electromagnetic coupling with the driven patch 110. The first parasitic patch 410 may be disposed electromagnetically adjacent to the driven patch 110. The first parasitic patch 410 may form the stacked structure with the driven patch 110. The spacing between the first parasitic patch 410 and the driven patch 110 or the arrangement position thereof may be adjusted.

The first parasitic patch 410 may include a first pattern 510 that overlaps with the plurality of antenna elements of the driven patch 110.

The first pattern 510 may include a plurality of first unit patches. For example, the first pattern 510 may include four first unit patches.

The first unit patch 515 may have a plurality of diagonal shapes. For example, the first unit patch 515 may have 4 diagonal shapes. Each of the plurality of diagonal shapes may be a diagonal shape that overlaps with each of the plurality of antenna elements. Each of the plurality of diagonal shapes may be disposed to have a difference of 90 degrees from an adjacent diagonal shape.

The first parasitic patch 410 may be a non-feeding element. The first parasitic patch 410 may be provided to adjust matching characteristics, radiation patterns, and gain characteristics of the antenna 100. The antenna 100 may extend the communication bandwidth through the first parasitic patch 410.

FIG. 6 is a diagram illustrating a second parasitic patch according to an embodiment.

Referring to FIG. 6, according to an embodiment, the second parasitic patch 430 may include a second pattern 610. The second pattern 610 may include a second unit patch 615.

The second parasitic patch 430 may be electromagnetically coupled with the driven patch 110. The second parasitic patch 430 may affect the radiation characteristics of the driven patch 110 through the electromagnetic coupling with the driven patch 110. The second parasitic patch 430 may be disposed electromagnetically adjacent to the driven patch 110. The second parasitic patch 430 may form the stacked structure with the driven patch 110. The spacing between the second parasitic patch 430 and the driven patch 110 or the arrangement position thereof may be adjusted.

The second parasitic patch 430 may include a second pattern 610 that overlaps with the plurality of antenna elements of the driven patch 110.

The second pattern 610 may include a plurality of second unit patches. For example, the second pattern 610 may include four second unit patches.

The second unit patch 615 may be cross-shaped. The second unit patch 615 may have a cross shape to cross between the plurality of antenna elements. The cross shape may be a cross shape that does not overlap with the plurality of antenna elements.

The second parasitic patch 430 may be a non-feeding element. The second parasitic patch 430 may be provided to adjust matching characteristics, radiation patterns, and gain characteristics of the antenna 100. The second parasitic patch 430 may be designed to operate under in-phase coupling conditions. The second parasitic patch 430 may improve the radiation gain of the antenna 100. The second parasitic patch 430 may reduce sidelobes of the antenna 100.

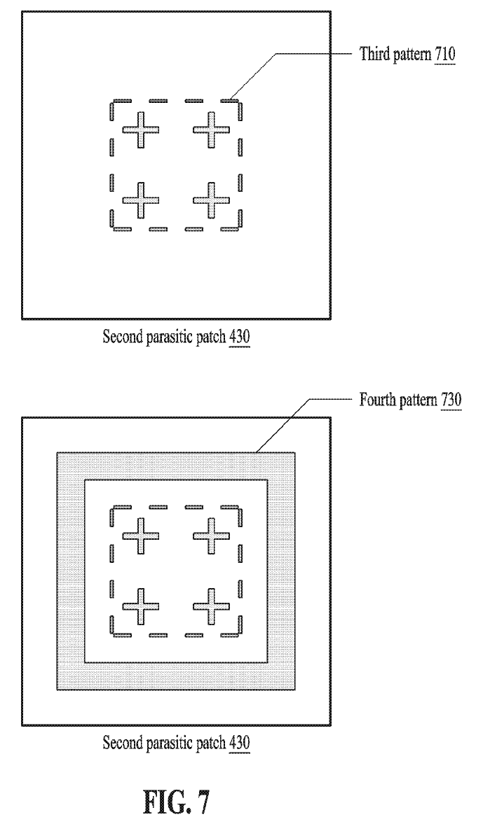

FIG. 7 is a diagram illustrating another example of a second parasitic patch according to an embodiment.

Referring to FIG. 7, according to an embodiment, the second parasitic patch 430 may further include a third pattern 710. The second parasitic patch 430 may further include a fourth pattern 730.

The third pattern 710 may have a shape of an outline of a rectangle surrounding the plurality of second unit patches. The outline shape of the third pattern 710 may be a shape that is broken at regular intervals.

The fourth pattern 730 may have a shape of an outline of a rectangle surrounding the plurality of second unit patches. The fourth pattern 730 may have a shape of an outline of a rectangle that is greater than the rectangle of the third pattern 710. The fourth pattern 730 may be a shape of an outline that is thicker than the outline of the third pattern 710.

The third pattern 710 and the fourth pattern 730 may be non-feeding elements. The third pattern 710 and the fourth pattern 730 may be provided to adjust matching characteristics, radiation patterns, and gain characteristics of the antenna 100.

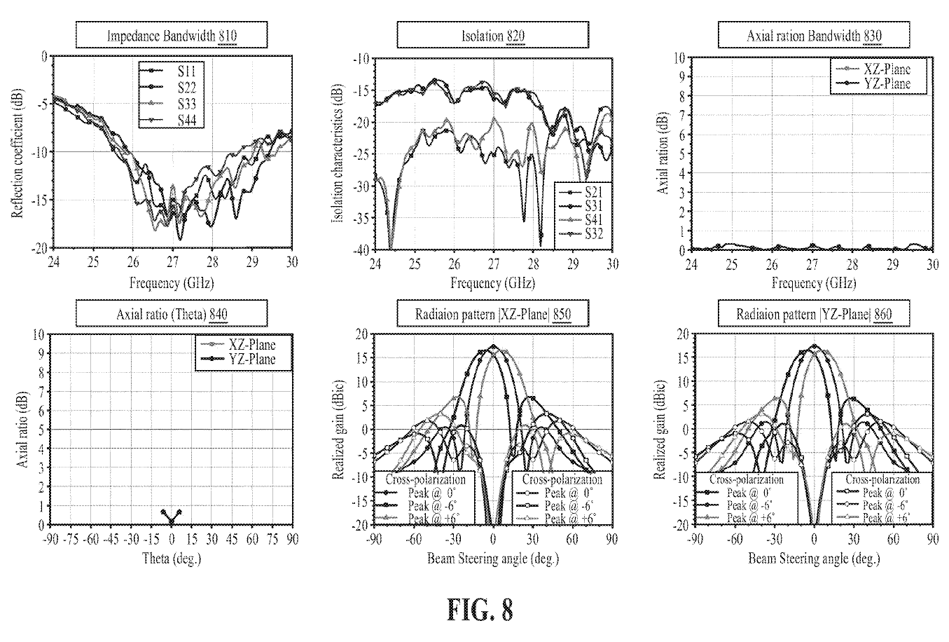

FIG. 8 is a diagram illustrating an electromagnetic simulation result of an antenna according to an embodiment.

A graph 810 may show characteristics of an impedance bandwidth of the antenna 100. The x-axis of the graph 810 may show a reflection coefficient, and the y-axis may show a measurement frequency band. The graph 810 may include analysis results for reflection coefficients (e.g., S11, S22, S33, and S44) among S-parameters. According to a simulation result, the sequential array structure of the antenna may be designed to secure an impedance bandwidth of approximately 10.9% at a center frequency of 27.5 GHz. The input matching characteristics of the antenna 100 may be maintained at a specific bandwidth.

A graph 820 may show isolation characteristics between ports of the antenna 100. The x-axis of the graph 820 may show the isolation characteristics, and the y-axis may show a measurement frequency band. The graph 820 may include analysis results for transmission coefficients (e.g., S21, S31, S41, and S32). The graph 820 may show the isolation characteristics of the antenna 100 between -15 dB and -35 dB in the Ka-band.

A graph 830 may show a simulation result for an axial ratio bandwidth of the antenna 100. The x-axis of the graph 830 may show an axial ratio, and the y-axis may show a measurement frequency band. Referring to the graph 830, the antenna 100 may maintain an axial ratio of 3 dB or less. Specifically, the axial ratio of the antenna 100 may be maintained between 1 dB and 2 dB in the Ka-band. The antenna 100 may be designed to have an axial ratio bandwidth of about 21.8% based on a center frequency of 27.5 GHz.

A graph 840 may show characteristics of a change in the axial ratio according to a radiation angle of the antenna 100. The x-axis of the graph 840 may show the radiation angle, and the y-axis may show the axial ratio. Referring to the graph 840, the antenna 100 may be designed to maintain an axial ratio of 1 dB or less in a radiation angle range between -15° and +15°.

A graph 850 may show a radiation pattern according to beam steering of the antenna 100 in the XZ plane. The x-axis of the graph 850 may show an angle of beam steering, and the y-axis may show a gain in a radial direction. Referring to the graph 850, a co-polarization component may exhibit a gain of 13 dBic to 15 dBic at steering angles of -6°, 0°, and 6°. A cross-polarization component may exhibit a low gain of -8 dBic to -12 dBic at steering angles of -6°, 0°, and 6°.

A graph 860 may show a radiation pattern according to the beam steering of the antenna 100 in the YZ plane. The x-axis of the graph 860 may show an angle of beam steering, and the y-axis may show a gain in a radial direction. Referring to the graph 860, a co-polarization component may exhibit a gain of 13 dBic to 15 dBic at steering angles of -6°, 0°, and 6°. A cross-polarization component may exhibit a low gain of -8 dBic to -12 dBic at steering angles of -6°, 0°, and 6°. Through the graphs 850 and 860, it may be seen that the antenna 100 may be designed so that a gain difference between the co-polarization component and the cross-polarization component is approximately 20 dBic.

Referring to the graphs 810 to 860, it may be seen that the antenna 100 has a uniform beam pattern compared to the existing CP antenna. Referring to the graphs 810 to 860, it may be seen that the gain change rate of the antenna 100 according to the frequency change is maintained at 1.32dB or less.

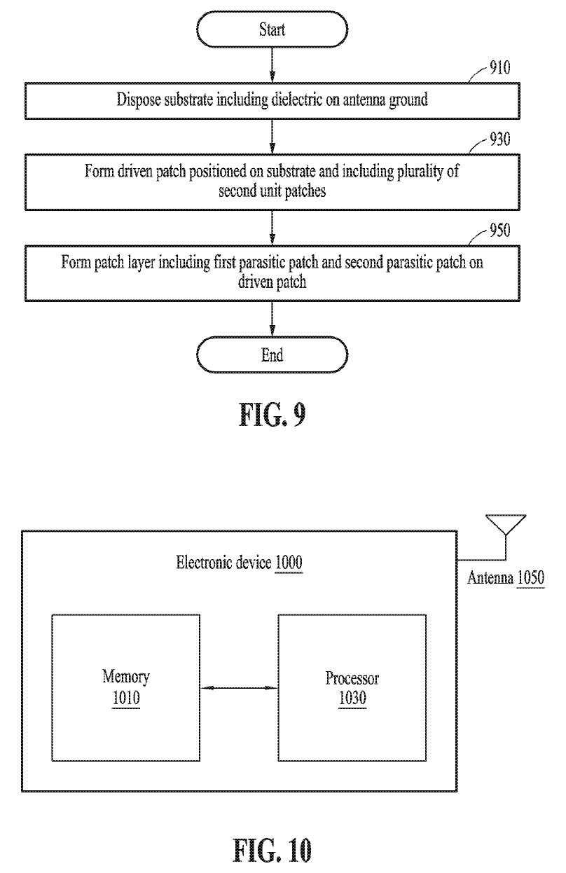

FIG. 9 is a flowchart illustrating a method of manufacturing an antenna according to an embodiment.

In operation 910, a substrate including a dielectric may be disposed on an antenna ground.

In operation 930, a driven patch positioned on the substrate and including a plurality of second unit patches may be formed.

In operation 950, a patch layer including a first parasitic patch and a second parasitic patch on the driven patch may be formed.

Each of the plurality of second unit patches may include a plurality of antenna elements. The first parasitic patch may include a first pattern that overlaps with the plurality of antenna elements. The second parasitic patch may include a second pattern that does not overlap with the plurality of antenna elements. The second parasitic patch may further include a third pattern. The third pattern may have a shape of an outline of a rectangle surrounding the plurality of unit patches. The outline may be broken at regular intervals. The second parasitic patch may further include a fourth pattern. The fourth pattern may be a shape of an outline of a rectangle that is greater than the rectangle of the third pattern and surrounds a plurality of unit patches.

FIG. 10 is a schematic block diagram illustrating an electronic device according to an embodiment.

Referring to FIG. 10, according to an embodiment, an electronic device 1000 may include a memory 1010, a processor 1030, and an antenna 1050.

The memory 1010 may store instructions (or programs) executable by the processor 1030. For example, the instructions may include instructions for performing an operation of the processor 1030 and/or an operation of each component of the processor 1030.

The memory 1010 may include one or more of computer-readable storage media. The memory 1010 may include non-volatile storage elements (e.g., a magnetic hard disc, an optical disc, a floppy disc, flash memory, electrically programmable memory (EPROM), and electrically erasable and programmable memory (EEPROM)).

The memory 1010 may be non-transitory media. The term "non-transitory" may indicate that a storage medium is not implemented as a carrier wave or propagated signal. However, the term "non-transitory" should not be interpreted to mean that the memory 1010 is immovable.

The processor 1030 may process data stored in the memory 1010. The processor 1030 may execute computer-readable code (e.g., software) stored in the memory 1010 and instructions triggered by the processor 1030.

The processor 1030 may be a data processing device implemented as hardware having a circuit having a physical structure for executing desired operations. For example, the desired operations may include code or instructions included in a program.

For example, the data-processing device implemented by hardware may include a microprocessor, a central processing unit (CPU), a processor core, a multi-core processor, a multiprocessor, an application-specific integrated circuit (ASIC), and a field-programmable gate array (FPGA).

The processor 1030 may cause the electronic device 1000 to perform one or more operations by executing code and/or instructions stored in the memory 1010. The operations performed by the electronic device 1000 may be substantially the same as the operations performed by the electronic device 1000 described above with reference to FIGS. 1 - 9. Accordingly, a repeated description thereof is omitted.

What is claimed is:

1. An antenna comprising:
a substrate comprising a dielectric;
a driven patch positioned on the substrate and comprising a plurality of second unit patches; and
a patch layer positioned on the driven patch and comprising a first parasitic patch and a second parasitic patch,
wherein each of the plurality of second unit patches comprises a plurality of antenna elements,
the first parasitic patch comprises a first pattern that overlaps with the plurality of antenna elements, and
the second parasitic patch comprises a second pattern that does not overlap with the plurality of antenna elements.

2. The antenna of claim 1, wherein
the first parasitic patch is disposed on one surface of a substrate included in the patch layer, and
the second parasitic patch is disposed on the other surface of the substrate included in the patch layer.

3. The antenna of claim 1, wherein
the first pattern comprises a plurality of first unit patches, and
each of the plurality of first unit patches is diagonal-shaped to overlap with each of the plurality of antenna elements.

4. The antenna of claim 3, wherein
each of the plurality of first unit patches comprises 4 diagonal shapes, and
each of the diagonal shapes is disposed to have a difference of 90 degrees from an adjacent diagonal shape.

5. The antenna of claim 1, wherein
the second pattern comprises a plurality of second unit patches, and
each of the plurality of second unit patches is cross-shaped to cross between the plurality of antenna elements.

6. The antenna of claim 1, wherein
the second parasitic patch further comprises a third pattern,
the third pattern has a shape of an outline of a rectangle surrounding the plurality of second unit patches, and
the outline is broken at regular intervals.

7. The antenna of claim 6, wherein
the second parasitic patch further comprises a fourth pattern, and
the fourth pattern has a shape of an outline of a rectangle having a size greater than the rectangle and surrounding the plurality of second unit patches.

8. A method of manufacturing an antenna, the method comprising:
disposing a substrate comprising a dielectric on an antenna ground;
forming a driven patch positioned on the substrate and comprising a plurality of second unit patches; and
forming a patch layer comprising a first parasitic patch and a second parasitic patch on the driven patch,
wherein each of the plurality of second unit patches comprises a plurality of antenna elements,
the first parasitic patch comprises a first pattern that overlaps with the plurality of antenna elements, and
the second parasitic patch comprises a second pattern that does not overlap with the plurality of antenna elements.

9. The method of claim 8, wherein
the first parasitic patch is disposed on one surface of a substrate included in the patch layer, and
the second parasitic patch is disposed on the other surface of the substrate included in the patch layer.

10. The method of claim 8, wherein
the first pattern comprises a plurality of first unit patches, and
each of the plurality of first unit patches is diagonal-shaped to overlap with each of the plurality of antenna elements.

11. The method of claim 10, wherein
each of the plurality of first unit patches comprises 4 diagonal shapes, and
each of the diagonal shapes is disposed to have a difference of 90 degrees from an adjacent diagonal shape.

12. The method of claim 8, wherein
the second pattern comprises a plurality of second unit patches, and
each of the plurality of second unit patches is cross-shaped to cross between the plurality of antenna elements.

13. The method of claim 8, wherein
the second parasitic patch further comprises a third pattern,
the third pattern has a shape of an outline of a rectangle surrounding the plurality of second unit patches, and
the outline is broken at regular intervals.

14. The method of claim 13, wherein
the second parasitic patch further comprises a fourth pattern, and
the fourth pattern has a shape of an outline of a rectangle having a size greater than the rectangle and surrounding the plurality of second unit patches.

15. An electronic device for inter-satellite communication, the electronic device comprising:
an antenna;
a processor; and
a memory,
wherein the antenna comprises:
a substrate comprising a dielectric;
a driven patch positioned on the substrate and comprising a plurality of second unit patches; and
a patch layer positioned on the driven patch and comprising a first parasitic patch and a second parasitic patch,
wherein each of the plurality of second unit patches comprises a plurality of antenna elements,
the first parasitic patch comprises a first pattern that overlaps with the plurality of antenna elements, and
the second parasitic patch comprises a second pattern that does not overlap with the plurality of antenna elements.

16. The electronic device of claim 15, wherein
the first parasitic patch is disposed on one surface of a substrate included in the patch layer, and
the second parasitic patch is disposed on the other surface of the substrate included in the patch layer.

17. The electronic device of claim 15, wherein
the first pattern comprises a plurality of first unit patches, and
each of the plurality of first unit patches is diagonal-shaped to overlap with each of the plurality of antenna elements.

18. The electronic device of claim 17, wherein
each of the plurality of first unit patches comprises 4 diagonal shapes, and
each of the diagonal shapes is disposed to have a difference of 90 degrees from an adjacent diagonal shape.

19. The electronic device of claim 15, wherein
the second pattern comprises a plurality of second unit patches, and
each of the plurality of second unit patches is cross-shaped to cross between the plurality of antenna elements.

20. The electronic device of claim 15, wherein
the second parasitic patch further comprises a third pattern,
the third pattern has a shape of an outline of a rectangle surrounding the plurality of second unit patches, and
the outline is broken at regular intervals.
